(19) United States
(12) Patent Application Publication
(10) Pub. No.: US 2008/0017660 A1
(43) Pub. Date: Jan. 24, 2008

(54) Article Storage And Retrieval Apparatus, And Vending Machine

(76) Inventor: Steven Michael Faes, Canisteo, NY (US)

Correspondence Address: PAUL D. BIANCO: FLEIT, KAIN, GIBBONS,;GUTMAN, BONGINI, & BIANCO P.L., 21355 EAST DIXIE HIGHWAY, SUITE 115, MIAMI, FL, 33180, US

(21) Appl. No.: 11/570,713

(22) PCT Filed: Jun. 15, 2004
(86) PCT No.: PCT/GB04/02501

§ 371 Date: Apr. 27, 2007

(51) Int. Cl. G07F 11/04

(52) U.S. Cl. 221/211; 221/258; 221/260

(57) ABSTRACT

Apparatus for storing and selectively retrieving articles includes a vertical array of storage locations each having a horizontal surface on which articles may rest and along which articles may be slid. A carriage is mounted for movement horizontally and vertically across the face of the array so as to be selectively positionable at any one of the locations, and an arm is mounted on the carriage and selectively extendible and retractable to engage and withdraw a selected article from a first one of the locations on to the carriage, the carriage then being movable to another of the locations at which the arm may be extended to discharge the article from the carriage into the other location.

### FIELD OF THE INVENTION

This invention relates to apparatus for storing and selectively retrieving articles, and to a vending machine incorporating such apparatus.

### BACKGROUND TO THE INVENTION

Until recent years most of the mechanisms used in various dispensing machines relied on fixed pitch spiral or fixed pitch conveyor delivery systems. Individual product selections required an individual mechanism for each product, consisting of a powered spiral or a powered segmented conveyor. Such machines suffer from a number of disadvantages, such as low volumetric efficiency of product density due to the fixed pitch nature of the spiral, physical damage to the products caused by forces induced by the spiral, and physically damage to the product caused by dropping the product to a delivery compartment.

An additional disadvantage to most vending machines is that the machines take a long time to load and must be loaded from the rear of the product tray which is a the furthest distance from the door opening. Fixed pitch type delivery systems require that each individual unit of product be placed into its respective slot or position for delivery, further slowing and complicating the loading process.

It is conventional that most vending machines that have a visible front door to view the product require that the product be placed some distance behind the glass partition of the door, thereby limiting the clarity of the products to be selected by the customer. Machines that are low on product appear unappealing to potential customers.

Most vending machines do not have a way to confirm that the product the customer has selected is the same product delivered to the customer. This is a disadvantage to the customer as well as the vending machine operators. It can lead to accounting errors as well as fraud. For example, some machine operator are subsidized by large corporate brands and are obligated to stock the contractually agreed brands. If the operator substitutes non-branded products for the contracted branded products, this can lead to reduced revenue for the corporate brand as well as a breach of contract.

U.S. Pat. Nos. 5,240,139 and 6,547,096 disclose package vending machines comprising means for lifting product with a vacuum pick mechanism in combination with product storage bins and display areas. The present invention seeks to provide a product vending machine of a similar type to this type of machine, but which has an improved mechanism for product dispensing, reliability, innovative product display capabilities, soft delivery, ease of loading and product recognition.

### SUMMARY OF THE INVENTION

Accordingly, the invention provides apparatus for storing and selectively retrieving articles, comprising a vertical array of storage locations each having a horizontal surface on which articles may rest and along which articles may be slid, a carriage mounted for movement horizontally and vertically across the face of the array so as to be selectively positionable at any one of the locations, and an arm mounted on the carriage and selectively extendible and retractable to engage and withdraw a selected article from a first one of said locations on to the carriage, the carriage then being movable to another of said locations at which the arm may be extended to discharge the article from the carriage into said other location.

The arm preferably comprises a telescopic suction tube, suitably connected to a fan driven by an electric motor. The tube preferably carries at the free end thereof an elastic cup surrounding the tube and engageable with the article.

The carriage preferably has mounted thereon a drum rotatable by a motor and carrying a flat flexible tape, the free end of which is attached to the free end of the tube whereby the tube may be selectively extended and retracted. A pressure detector may be provided in the suction tube to detect a decrease in pressure resulting from engagement of the tube with the article to be withdrawn, the drum motor being controllable to reverse direction when the decrease is detected, thereby withdrawing the article.

The carriage is conveniently mounted to slide along a horizontal rail which is in turn slidably mounted on a vertical rail, motors being provided for selectively moving the carriage along the horizontal rail and the horizontal rail along the vertical rail.

An optical detector may be provided on the carriage for identifying the article in a storage location. The detector may comprise a digital camera, and this may be linked to image processing and storage means, whereby an image generated by the camera can be compared with stored reference images to identify the article stored at any storage location. Thus, for example, a record may be built up of the articles stored in different locations to facilitate their retrieval.

The array of storage locations preferably includes a delivery location from which an article may be manually retrieved, or alternatively from which it can be transported, for example by a conveyor mechanism.

The invention also provides a vending machine comprising apparatus according to the invention for storing and selectively retrieving articles, located within a closed cabinet providing access only to said delivery location, selection means on the cabinet for sending an article selection signal to control means to indicate the choice of article to be vended by the machine, and payment means for receiving a payment in relation to the article and for sending a payment signal to the control means when the payment has been received, wherein the control means is arranged to control the movement of the carriage and the operation of the arm in response to receipt of the article selection and payment signals to deliver the selected article from the respective storage location to said delivery location.

Preferably, the cabinet is provided with a transparent panel in one vertical face thereof, and the array of storage locations is positioned with the vertical face thereof opposite to that over which the carriage is movable adjacent to the transparent panel, whereby the contents of all the storage locations are visible from outside the cabinet.

The cabinet may include a door for the delivery location, the door preferably being provided with a lock controllable by the control means to release the door when the selected article has been delivered to the delivery location.

The storage and retrieval apparatus of the invention eliminates the need for fixed pitch spirals or segmented conveyors and furthermore the need to drop a product for delivery, improving delivery reliability and minimizing the risk of damage to the product or article. The products or articles can be displayed in a vending machine in the manner of a store window, allowing for improved customer visibility and therefore improved sales.

### BRIEF DESCRIPTION OF THE DRAWINGS

In the drawings, which illustrate exemplary embodiments of the invention:

FIG. 1 is a perspective view of a vending machine in accordance with the invention;

FIG. 2 is a view corresponding to that of FIG. 1, with the front panel of the machine removed;

FIG. 3 is a view of a product selector mechanism suitable for use in the machine of FIGS. 1 and 2;

FIG. 4 is an enlarged perspective view of the telescoping pick mechanism which forms part of the product selector mechanism;

FIG. 5 is a side elevation of the mechanism of FIG. 4;

FIGS. 6 to 8 are side views of the machine of FIG. 1, with the casing removed, showing successive stages in the product cycle; and

FIG. 9 is a perspective view of the machine at the stage at which the product is released to the customer.

### DETAILED DESCRIPTION OF THE ILLUSTRATED EMBODIMENTS

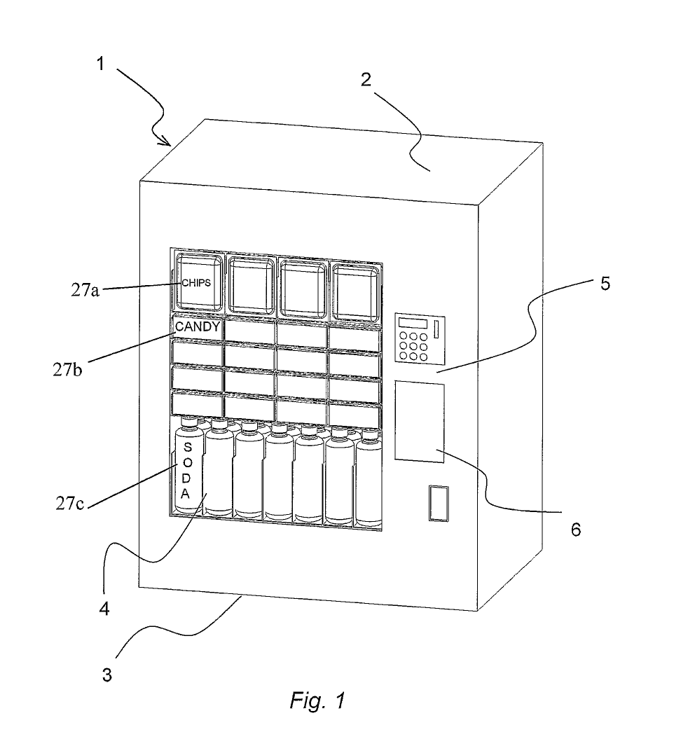

FIG. 1 shows a vending machine 1 with a rectangular shape cabinet 2 including a front door 3, a product display panel 4 which is preferably transparent, a product selection panel 5 and a product delivery door 6. The product display panel 4 may be non-transparent for most aspects of the invention as claimed further to exist.

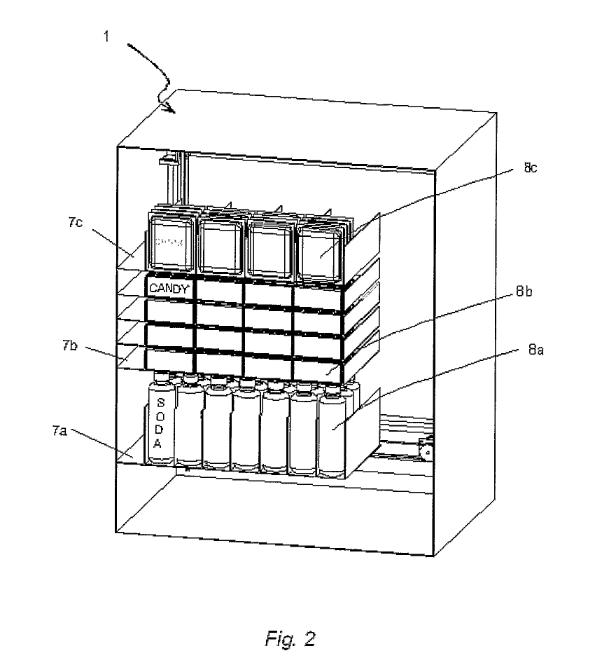

FIG. 2 illustrates the vending machine 1 with the front door 3 removed for clarity. Directly behind the transparent product display panel 4 resides a series of product trays 7a-7b. The product trays 7a-7b are shown with a plurality of products 8a-8c stored on them. The trays 7a-7b are arranged in such a way as to allow the products 8a-8c to be viewed from the customer in a clear and easily recognizable manor. The product labelling 27a-c can be viewed in a normal reading orientation by the customer. The products 8a-8c can be loaded into the trays 7a-7b directly from the front of the vending machine 1 when the front door 3 is opened.

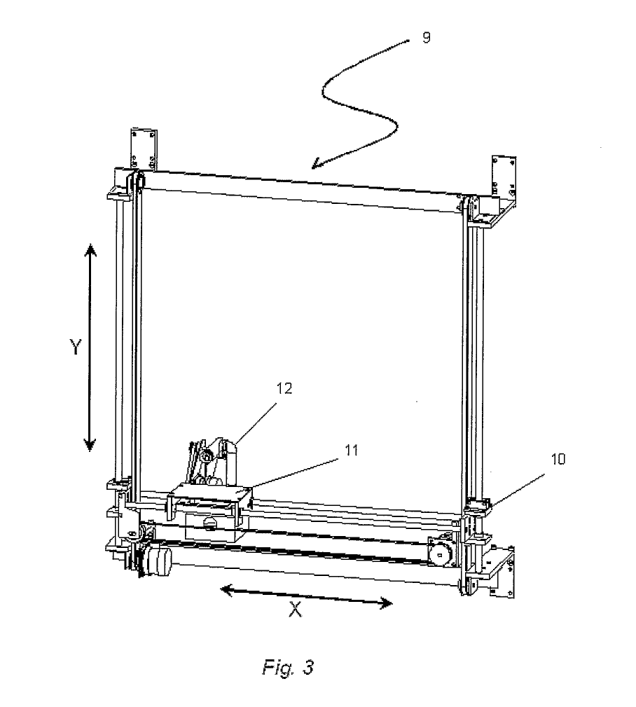

FIG. 3 shows the vending machine 1 with the cabinet completely removed for clarity. An x-y drive mechanism 9 consists of a motorized elevator 10 for creating motion in the y or vertical direction and a motorized carriage or table 11 for creating motion in the x or transverse direction. Attached to the table 11 is a telescoping vacuum pick mechanism 12 which is described in detail below.

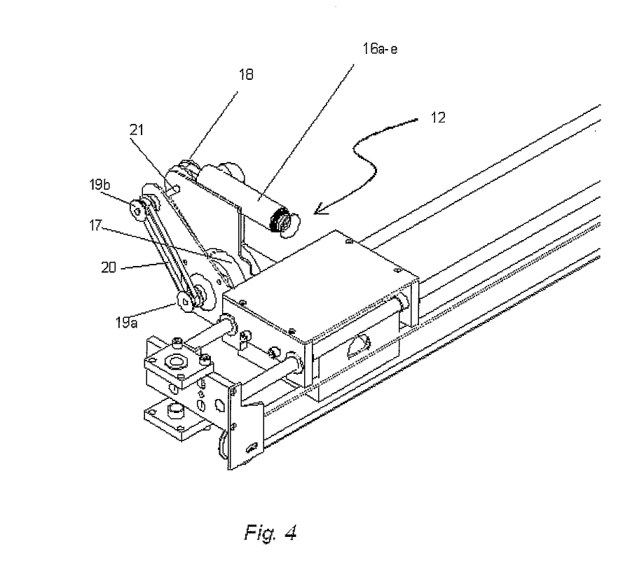

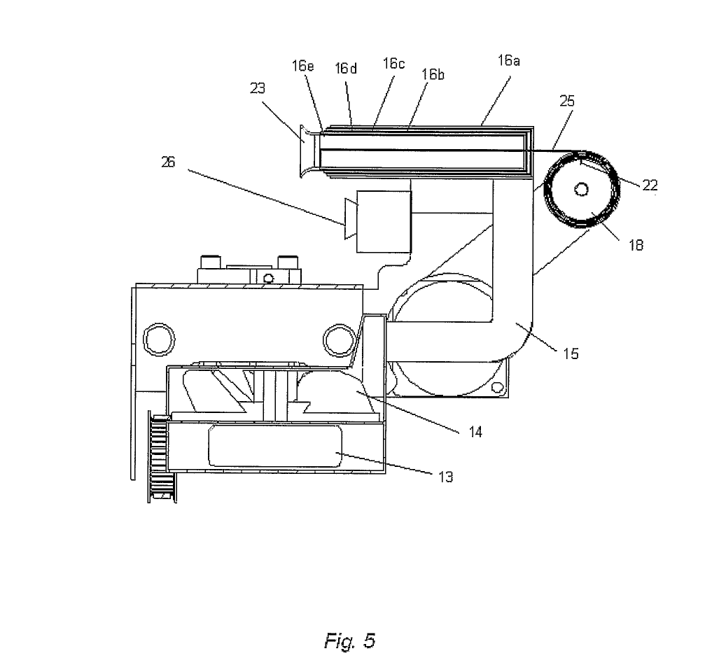

Referring now to FIGS. 4 and 5, a telescoping pick mechanism 12 consists of a vacuum fan motor 13, a vacuum fan 14 and a suction tube 15 which are rigidly mounted to the table 12. The suction tube 1 5 is attached to s series of telescoping tubes 16a-16e. Tube 16a is rigidly affixed to the table 11 and connected to the vacuum suction tube 15.

A motor 17 is affixed to the table 11 and connected to a drive drum 18 by means of pulleys 19a-19b, belt 20, and drive shaft 21. A flat flexible member 25 is connected to the drum 18 by means of a folded tab 22. The member 25 is connected to the end of tube 16e. Also connected to the tube 16e is an elastic suction cup 23. As motor 17 is energized the drum 18 is caused to rotate imparting a force on the member 25 which in turn imparts a force on tube 16e causing it to move in a linear direction and telescope outwards increasing the length of the pick mechanism 12. As tube 16e extends further, it contacts and then imparts a force on tube 16d causing it to move linearly. The same motion can be generated for the tubes 16b and 16c. When the motor 17 is reversed the forces are then applied in an opposite direction, causing the tubes 16b-16e to collapse. The tubes 16a-16e are contracted in such a way as to provide an air path for providing negative pressure (vacuum) at the elastic cup 23.

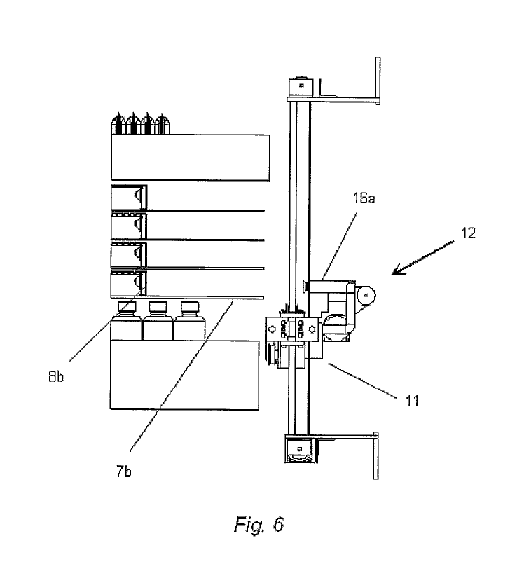

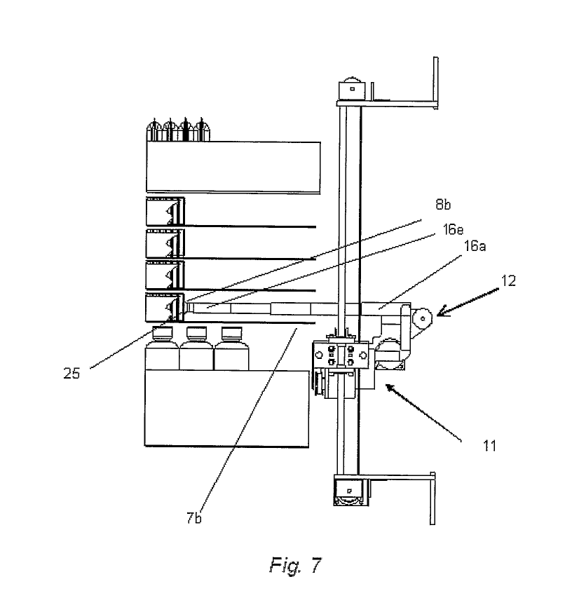

Referring now to FIGS. 6-9, a product cycle is described. A customer would normally select a product by using the panel 5 (shown in FIG. 1). When a product is selected, the drive mechanism 9 positions the table 11 in such a way as to align the pick mechanism 12 with the appropriate product. Referring now to FIG. 6, the pick mechanism is positioned so as to be able to retrieve a product 8b. The telescoping pick mechanism is then energized and caused to extend. As shown in FIG. 7, the motor 17 has been energized causing the tubes 16b-16e to extend. A pressure gauge 24 and a current detect circuit on the fan motor 13 detect a drop in pressure and an increase in current to determine when contact between the elastic cup 23 and the product 8b has been made.

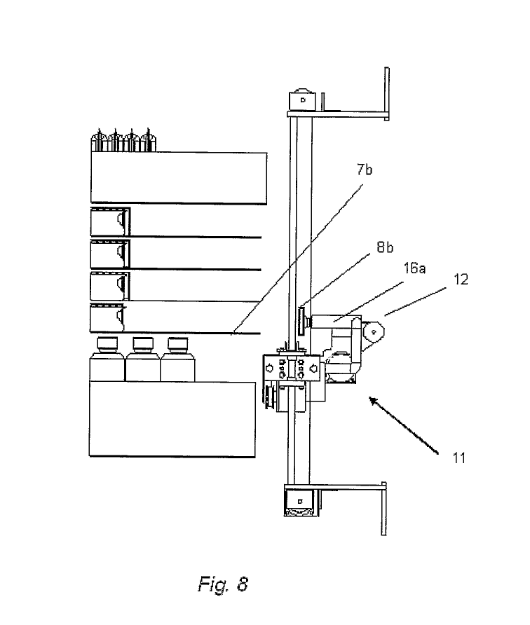

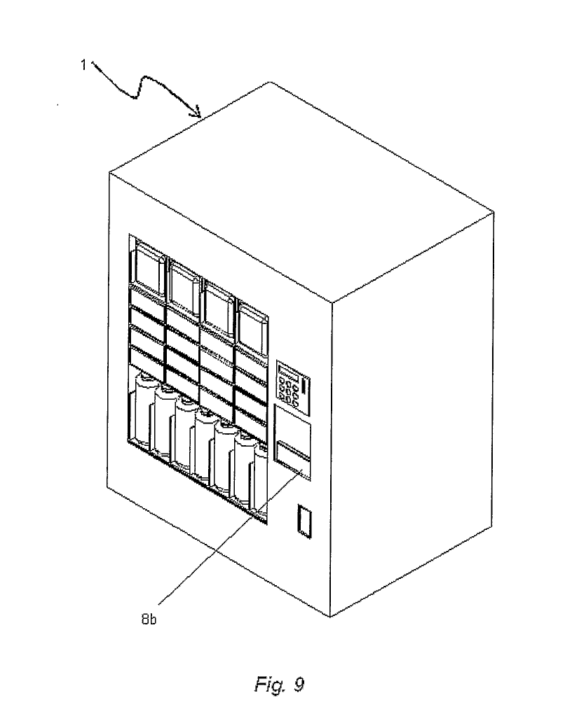

The motor 17 is then reversed, causing the tubes 16b-16e to collapse as shown in FIG. 8. Referring now to FIG. 9, the x-y mechanism is then energized in such a way as to align the pick mechanism 12 with the product retrieval door 6. The motor 17 is then energized causing the tube 16b-16e to extend the product to the retrieval door 6. In this manner, the tube serves simply to push the product on to the delivery space behind the retrieval door 6, without the need for suction in the tube, and without causing the product to drop. The door 6 is then opened manually or by motor/solenoid means and the product 8b can be retrieved by the customer.

An optical correlator 26 can be mounted to the table 11 in such a way that a stable optical image of any product selected can then be taken. The image is then sent to local or remote data base to correlate product selected versus product delivered.

1. Apparatus for storing and selectively retrieving articles, comprising a vertical array of storage locations each having a horizontal surface on which articles may rest and along which articles may be slid, a carriage mounted for movement horizontally and vertically across the face of the array so as to be selectively positionable at any one of the locations, and an arm mounted on the carriage and selectively extendible and retractable to engage and withdraw a selected article from a first one of said locations on to the carriage, the carriage then being movable to another of said locations at which the arm may be extended to discharge the article from the carriage into said other location.

2. Apparatus according to claim 1, wherein the arm comprises a telescopic suction tube.

3. Apparatus according to claim 2, wherein the suction tube is connected to a fan driven by an electric motor.

4. Apparatus according to claim 2, wherein the suction tube carries at the free end thereof an elastic cup surrounding the tube and engageable with the article.

5. Apparatus according to claim 2, wherein the carriage has mounted thereon a drum rotatable by a motor and carrying a flat flexible tape, the free end of which is attached to the free end of the tube whereby the tube may be selectively extended and retracted.

6. Apparatus according to claim 5, comprising a pressure detector in the suction tube to detect a decrease in pressure resulting from engagement of the tube with the article to be withdrawn, the drum motor being controllable to reverse direction when the decrease is detected, thereby withdrawing the article.

7. Apparatus according to claim 1, wherein the carriage is mounted to slide along a horizontal rail which is in turn slidably mounted on a vertical rail, motors being provided for selectively moving the carriage along the horizontal rail and the horizontal rail along the vertical rail.

8. Apparatus according to claim 1, comprising an optical detector on the carriage for identifying the article in a storage location.

9. Apparatus according to claim 8, wherein the optical detector comprises a digital camera.

10. Apparatus according to claim 9, wherein the camera is linked to image processing and storage means, whereby an image generated by the camera can be compared with stored reference images to identify the article stored at any storage location.

11. Apparatus according to claim 1, wherein the array of storage locations comprises a delivery location from which an article may be manually retrieved.

12. A vending machine comprising apparatus according to claim 9, located within a closed cabinet providing access only to said delivery location, selection means on the cabinet for sending an article selection signal to control means to indicate the choice of article to be vended by the machine, and payment means for receiving a payment in relation to the article and for sending a payment signal to the control means when the payment has been received, wherein the control means is arranged to control the movement of the carriage and the operation of the arm in response to receipt of the article selection and payment signals to deliver the selected article from the respective storage location to said delivery location.

13. A vending machine according to claim 12, wherein the cabinet is provided with a transparent panel in one vertical face thereof, and the array of storage locations is positioned with the vertical face thereof opposite to that over which the carriage is movable adjacent to the transparent panel, whereby the contents of all the storage locations are visible from outside the cabinet.

14. A vending machine according to claim 13, comprising a door in the cabinet for the delivery location.

15. A vending machine according to claim 14, wherein the door is provided with a lock controllable by the control means to release the door when the selected article has been delivered to the delivery location.
